(19) United States
(12) Patent Application Publication
(10) Pub. No.: US 2016/0283333 A1
(43) Pub. Date: Sep. 29, 2016

(54) UTILIZING A PROCESSOR WITH A TIME OF DAY CLOCK ERROR

(71) Applicant: International Business Machines Corporation, Armonk, NY (US)

(72) Inventors: Sachin Gupta, Bangalore (IN); Prem S. Jha, Bangalore (IN); Venkatesh Sainath, Bangalore (IN)

(21) Appl. No.: 14/667,849

(22) Filed: Mar. 25, 2015

(51) Int. Cl. G06F 11/16; G06F 1/10

(52) U.S. Cl. CPC G06F 11/1604; G06F 1/10; G06F 11/1679

(57) ABSTRACT

Aspects of the present invention disclose a method for core utilization. The method includes identifying a faulty clock in a core of a plurality of cores. The method further includes initiating a recovery procedure of the faulty clock in the affected core. The method further includes determining that the recovery of the faulty clock was not successful. The method further includes adjusting the functionality of the core with the faulty clock.

### BACKGROUND OF THE INVENTION

The present invention relates generally to the field of computer processors, and more particularly to asset allocation within multi-processor or multi-core computer environments.

In a computer system, the processor is the system component that reads and executes program instructions. A multi-processor computer system involves a system with a plurality of processors, either single- or multi-core, capable of independent operation to process separate tasks in parallel. Symmetric multiprocessing (SMP) is the most common configuration of a multi-processor computer system. A typical SMP system has the following items: multiple processors and exactly one of everything else—operating system (OS), input/output (I/O) system, primary memory, system clock, etc. The single OS, having insight to all system elements at all times, can: transparently allocate shared resources on multiple processors and/or cores; dynamically schedule any application to run on any available processor and/or core to maximize processor/core utilization; and provide dynamic memory allocation which allows all processors and/or cores to draw on the full pool of available memory without a performance penalty. Other rationale for a particular task assignment can be task priority, size of the task, required attributes of a given task, etc. For example, some tasks are independent of time, such as most mathematical computations. For others, an accurate time stamp is required for the task to be valid. One such set of tasks are financial transactions.

### SUMMARY

Aspects of the present invention disclose a method for core utilization. The method includes identifying a faulty clock in a core of a plurality of cores. The method further includes initiating a recovery procedure of the faulty clock in the affected core. The method further includes determining that the recovery of the faulty clock was not successful. The method further includes adjusting the functionality of the core with the faulty clock.

### BRIEF DESCRIPTION OF THE DRAWINGS

FIG. 1 illustrates a functional block diagram of a multi-processor computing system using a hypervisor to allocate resources over a plurality of processors, in accordance with an embodiment of the present invention.

FIGS. 2A and 2B are flowcharts illustrating steps involved in allocating processor resources in a multi-processor computing system, in accordance with an embodiment of the present invention.

FIG. 3 depicts a block diagram of the components of a computing system representative of the multi-processor computing system of FIG. 1, in accordance with an embodiment of the present invention.

### DETAILED DESCRIPTION

Embodiments of the present invention recognize that not all core or processor faults render the core or processor inoperable. The core or processor may still have partial functionality and may still provide value to a multi-core or multi-processor computing system.

Some embodiments of the present invention allow for the utilization of a core or processor, in a multi-core or multi-processor computing system, with a faulty clock. Once a faulty clock is identified, it can be tested and an attempt to recover (or reset) the faulty clock can be made. If the clock still proves faulty, the remaining non-clock functions, which are functions not dependent on an accurate clock, of the core or processor with the faulty clock are tested. If those non-clock functions work properly, the affected core or processor handles the non-clock functions. This partial utilization enables the multi-core/multi-processor computing system to operate at its highest capability possible given the faulty clock.

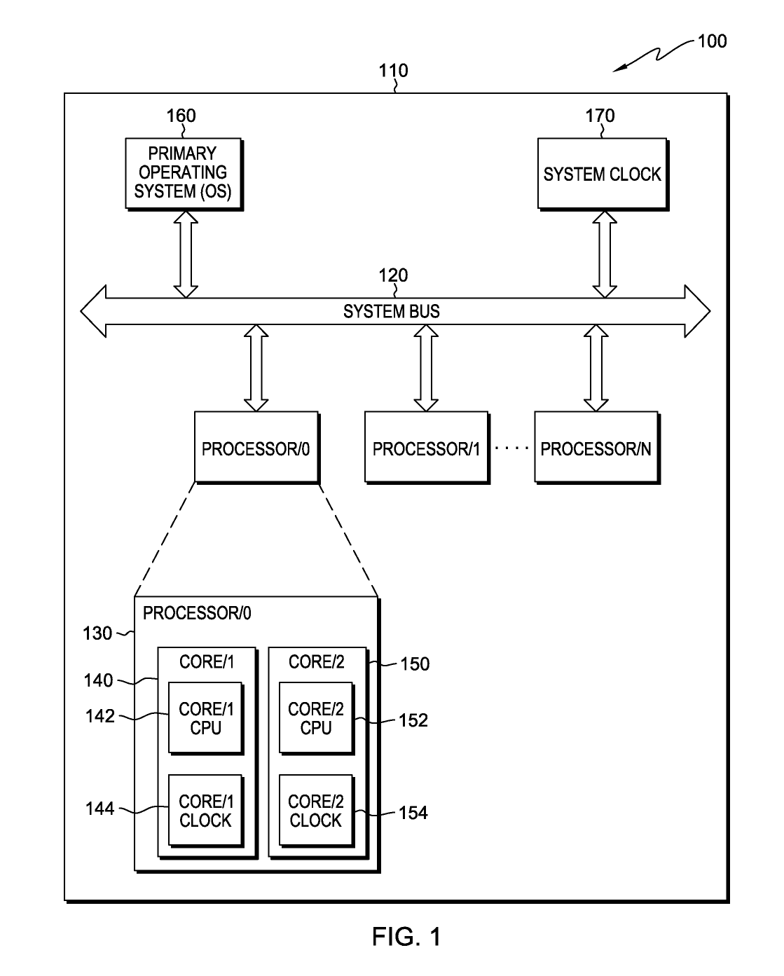

The following paragraphs will describe the present invention in detail with references to the Figures. FIG. 1 is a functional block diagram of a multi-processor computing system, generally designated 100, in accordance with one embodiment of the present invention.

In an embodiment, multi-processor computing system 100 includes computer 110 which is representative of a typical multi-processor computer. Computer 110 includes system bus 120, processor/0 through processor/n, primary operating system (OS) 160, and system clock 170. This representation of computer 110 provides only an illustrative embodiment of one implementation and does not imply any limitations with regard to computer 110.

Processor/0 130 can be a single core integrated circuit or it can include multiple cores (e.g., 2 cores as illustrated in the block diagram of computer 110). The designation ‘n’ in processor/n indicates that there can be ‘n’ number of processors in the multi-processor computing system. In other embodiments, multi-processor computing system 100 can include other computing devices such as computer servers, desktop computers, laptop computers, tablet computers or any other computing system known in the art. Each one of those computing systems can consist of multi-core and/or multi-processor devices. These devices communicate through a network which may be a local area network (LAN), a telecommunications network, a wide area network (WAN) such as the Internet, or any combination of the three, and include wired, wireless or fiber optic connections. In general, the network can be any combination of connections and protocols that will support communications between devices, in accordance with embodiments of the present invention.

System bus 120 is the communication system that transfers data between components inside a computer, or between computers. In various embodiments of the present invention, system bus 120 can be an electronic circuit, wires, cables, fiber optics, software communication protocols or any other means of providing data transfer. In an example embodiment, system bus 120 connects processor/0 130, primary OS 160, and system clock 170, and provides a communication path between the three components.

Processor/0 130 is representative of an integrated circuit (or chip) with 2 cores. In an example embodiment, processor/0 130 includes two or more cores that can provide enhanced performance, reduced power consumption, and more efficient simultaneous processing of multiple tasks for the processor. A multi-core processor implements multiprocessing in a single physical package. Each core, such as core/1 140 and core/2 150 includes a CPU (core/1 CPU 142 and core/2 CPU 152) and a clock (core/1 clock 144 and core/2 clock 154). This representation of processor/0 130 provides only an illustrative embodiment of one implementation and does not imply any limitations with regard to processor/0 130.

Core/1 140 and core/2 150 are each one of a plurality of processing units in a single computing component. Each has the ability to read and execute program instructions such as add, move data and branch. Since multiple cores can run multiple processes at the same time, the overall speed for executing the program instructions is increased. In accordance with an embodiment of the present invention, processor/0 130 is a dual-core processor.

Core/1 CPU 142 and core/2 CPU 152 are the central processing units contained in each core of a multi-core processor such as processor/0 130. The CPU of a computer is the electronic circuitry within that computer that carries out the instructions of a computer program by performing the basic arithmetic, logical, control and input/output (I/O) operations specified by the instructions. Core/1 CPU 142 and core/2 CPU 152 are each able to execute a set of instructions assigned by primary OS 160 to processor/0 130, via system bus 120, in accordance with an embodiment of the present invention.

Core/1 clock 144 and core/2 clock 154 are the clocks contained in each core of a multi-core processor such as processor/0 130. In an example embodiment, core/1 clock 144 and core/2 clock 154 each receives the clock signal from system clock 170, via system bus 120. Receiving this signal enables core/1 clock 144 and core/2 clock 154 to keep synchronous time with system clock 170, in accordance with an embodiment of the present invention. Synchronous time between all of the clocks in a multi-core/multi-processor computing system allows the system to function accurately.

In various embodiments of the present invention, primary OS 160 is software that manages computer hardware and software resources and provides a stable and consistent way for applications to interact with the computer hardware without having to know all the details of the hardware. The OS is an essential component of the system software in a computer system; in general, the tasks of the OS are processor management, memory management, device management, storage management, application interface, and user interface. In an embodiment, a function of primary OS 160 is to allocate the hardware and software resources of the computer. For example, primary OS 160 can allocate hardware resources such as system clock 170 and the plurality of processors, represented by processor/0 through processor/n, in a multi-processor computing system. In example embodiments, primary OS 160 can be the operating system for a desktop computer, can be depicted as a Type 1 or Type 2 hypervisor in a virtualized environment, and can operate in cloud applications where groups of remote servers and software networks allow centralized data storage and online access to computer services and/or resources. Primary OS 160 can assign appropriate workload to a core or processor based on that core or processor having a faulty component such as a clock.

System clock 170 measures system time, which represents a computer's notion of the passing of time, in computer 110. In one embodiment, system clock 170 is a clock that acts like a common wall clock for all of the processors, providing a common reference point (e.g., the time of day value) synchronizing all of the processes running on the various cores of the various processors. In another embodiment, system clock 170 is a simple count of ‘ticks’ that have transpired since some arbitrary starting date (e.g., the epoch). This count is the system time. It is possible to convert system time into calendar time, which is more suitable for human comprehension, using a subroutine written for that task. Another name for the ‘ticks’ that make up the system time is the clock signal. The clock distribution network inside the CPU carries that clock signal to all the parts of the computer that need it. The clock signal coordinates the actions of integrated circuits not unlike a metronome keeping the beat for a conductor. In one embodiment, a crystal oscillator, which is an electronic oscillator circuit that uses the mechanical resonance of a vibrating crystal of piezoelectric material to create an electrical signal with very precise frequency, produces the clock signals. For the multi-processor computing system to function correctly, all of the processor and/or core clocks must remain in synchronization with the system clock. If the clocks do not remain “in sync”, errors can occur such as incorrect time stamps on financial transactions and calculation errors in the case of processors having a precedence relationship (task ‘A’ on processor ‘A’ must complete before task ‘B’ on processor ‘B’ runs).

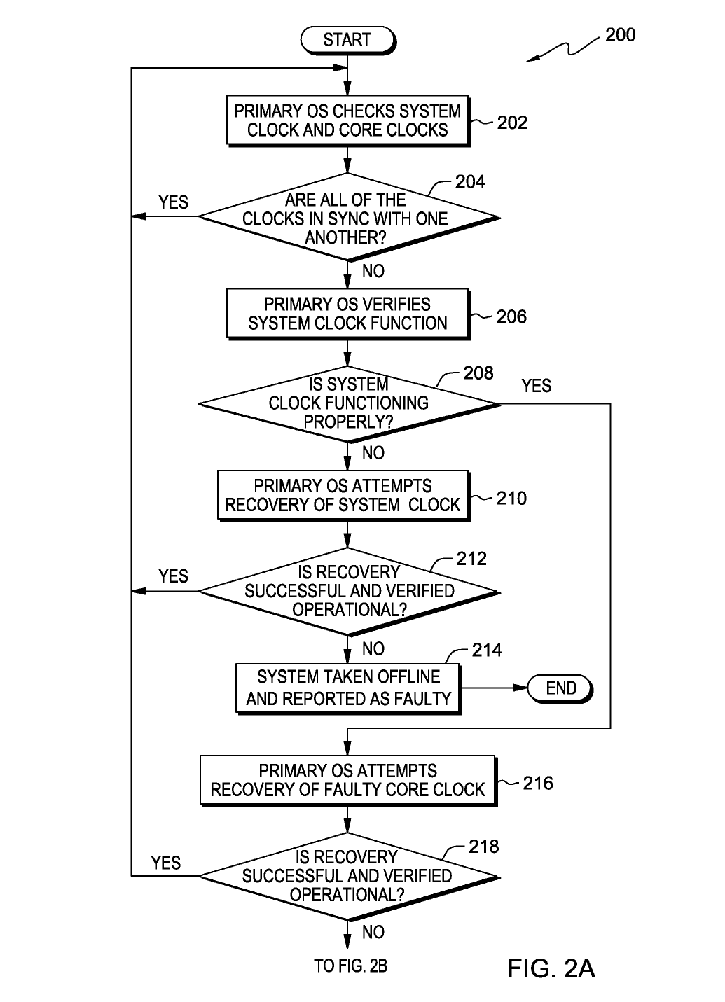

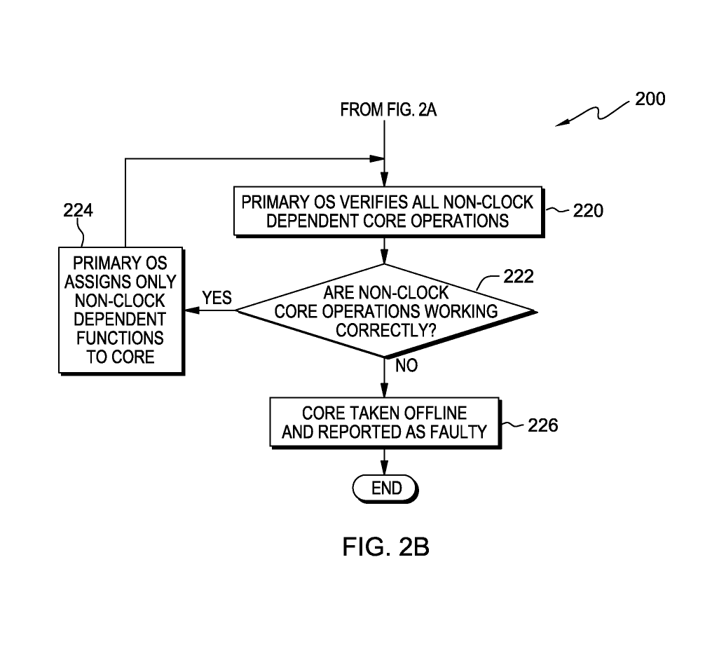

FIG. 2 is a flowchart depicting the operational steps for the utilization of a core that has a clock error, in accordance with an embodiment of the present invention. In one embodiment, core/1 clock 144, in processor/0 130, is out-of-sync with system clock 170, which causes primary OS 160 to attempt a recovery of core/1 clock 144 and upon failing, to assign only non-clock dependent operations to the core. A non-clock dependent operation is one that does not require an accurate clock reference to function correctly. This procedure allows for the utilization of a processor or core with a faulty clock, enabling the processor or core to continue to provide function to the multi-core/multi-processor computing system. The alternative is to disable the affected processor or core which impacts the overall functionality of the multi-processor computing system.

In step 202, primary OS 160, or system hardware, or both in parts run an internal check to verify the integrity of the time of day value as seen by each core and processor in the multi-processor computing system. In various embodiments of the present invention, this check occurs continuously, hourly, daily, or during the power-on self-test (POST) of the multi-processor computing system.

In decision step 204, primary OS 160 determines whether the system and processor clocks are in sync (step 202). In one embodiment, if primary OS 160 determines that the clocks are in sync (step 204, YES branch), then primary OS 160 repeats the step 202 check at pre-defined intervals. If primary OS 160 determines that the clocks are not in sync (step 204, NO branch), then primary OS 160 initiates step 206.

In step 206, since primary OS 160 has verified that the various clocks in computer 110 are not in sync with one another, primary OS 160 now confirms whether system clock 170 is functioning properly. In an example embodiment, primary OS 160, or system hardware, or both in parts run an internal check to verify the elapsed time as seen by each processing unit (e.g., core/1 140 and core/2 150).

In decision step 208, primary OS 160 determines whether system clock 170 is functioning correctly (step 206) by running an internal check to verify the elapsed time seen by system clock 170. In one embodiment, if primary OS 160 determines that system clock 170 is accurate and functioning properly (step 208, YES branch), then primary OS 160 proceeds to step 216 and attempts recovery of the faulty processor/core clock as described below. If primary OS 160 determines that system clock 170 is faulty and not functioning properly (step 208, NO branch), then primary OS 160 proceeds to step 210.

In step 210, since primary OS 160 has determined that system clock 170 is faulty (step 206), primary OS 160 attempts to recover the system clock. In an example embodiment, primary OS 160 can attempt to switch to a redundant oscillator or redundant master clock. In another embodiment, primary OS 160 can attempt to switch to a redundant clock topology. Clock topology is a preconfigured chosen path where the clock ticks are propagating between various processing units in the multi-processor computing system.

In decision step 212, primary OS 160 determines if recovery of system clock 170 (step 210) is successful. In one embodiment, if the recovery was successful and system clock 170 is again accurate and functioning properly (step 212, YES branch), then primary OS 160 repeats the step 202 check at pre-defined intervals. If the recovery was not successful and system clock 170 is still faulty (step 212, NO branch), then primary OS 160 proceeds to step 214.

In step 214, since primary OS 160 was unable to recover faulty system clock 170 (step 210), primary OS 160 reports the faulty condition and takes computer 110 offline.

In step 216, primary OS 160 has previously confirmed that system clock 170 is functioning properly (step 208) so primary OS 160 now attempts to recover faulty core/1 clock 144, which is one of the core clocks in processor/0 130. In an example embodiment, primary OS 160 can attempt to switch to a redundant clock source. In another embodiment, primary OS 160 can attempt to switch to a redundant clock topology. Clock topology is a preconfigured chosen path where the clock ticks are propagating between various processing units in the multi-processor computing system.

In decision step 218, primary OS 160 determines whether recovery of faulty core/1 clock 144 (step 216) is successful by running an internal check to verify the elapsed time seen by core/1 clock 144. In one embodiment, if the recovery was successful and core/1 clock 144 is again accurate and functioning properly (step 218, YES branch), then primary OS repeats the step 202 check at pre-defined intervals. If the recovery was not successful (step 218, NO branch), then primary OS 160 proceeds to step 220.

In step 220, primary OS 160 determines that core/1 clock 144 in processor/0 130 is faulty and unable to be recovered (step 218), primary OS 160 now verifies, using a built-in diagnostic tool from the processor manufacturer or one from a commercial supplier, that all of the non-clock dependent operations of the core(s) are working correctly. A non-clock dependent operation is one that does not require an accurate clock reference to function correctly and the operation does not have to interact with the other cores or processors in the multi-processor computing system.

In decision step 222, primary OS 160 determines whether the non-clock dependent operations of core/1 clock 144 are functioning correctly (step 220). In one embodiment, if the non-clock dependent operations in core/1 140 are not working properly (step 222, NO branch), then primary OS 160 initiates step 226. If the non-clock dependent operations in core/1 140 are working properly (step 222, YES branch), then primary OS 160 proceeds to step 224.

In step 224, since the non-clock dependent operations of core/1 140 are working properly (step 222), primary OS 160 now assigns only non-clock dependent operations to the core. In an example embodiment, primary OS 160 identifies independent blocks of operations or applications that can operate on a chosen core without having to interact with the rest of the system. In one embodiment, operations assigned are tasks such as simple arithmetic or spell checking. In another embodiment, operations not assigned are tasks such as financial transactions. Primary OS 160 continues to monitor the functionality of the non-clock dependent operations of core/1 140 by initiating step 220.

In step 226, since the non-clock dependent operations of core/1 140 are not working correctly (step 222), primary OS 160 reports core/1 140 as faulty and takes the core offline. In an example embodiment, since processor/0 130 is a dual-core processor and only core/1 140 is deemed faulty, the processor still remains functional at some diminished capacity and capability.

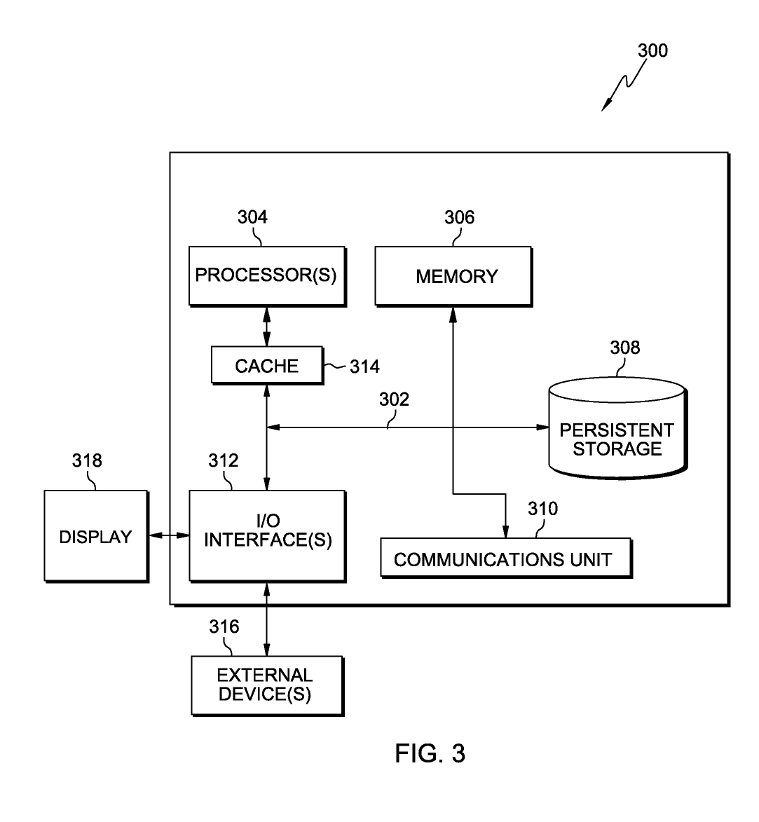

FIG. 3 depicts a block diagram of components of computer 300, which is representative of computer 110, in accordance with an illustrative embodiment of the present invention. It should be appreciated that FIG. 3 provides only an illustration of one implementation and does not imply any limitations with regard to the environments in which different embodiments can be implemented. Many modifications to the depicted environment can be made.

Computer 300 includes processor(s) 304 (e.g., processor/0 through processor/n of FIG. 1), cache 314, memory 306, persistent storage 308, communications unit 310, input/output (I/O) interface(s) 312 and communications fabric 302. Communications fabric 302 provides communications between cache 314, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses, such as system bus 120 in FIG. 1.

Memory 306 and persistent storage 308 are computer readable storage media. In this embodiment, memory 306 includes random access memory (RAM). In general, memory 306 can include any suitable volatile or non-volatile computer readable storage media. Cache 314 is a fast memory that enhances the performance of processor(s) 304 by holding recently accessed data, and data near recently accessed data, from memory 306. With respect to computer 110, persistent storage 308 includes primary OS 160.

In this embodiment, persistent storage 308 includes a magnetic hard disk drive. Alternatively, or in addition to a magnetic hard disk drive, persistent storage 308 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer readable storage medium that is also part of persistent storage 308.

Communications unit 310, in these examples, provides for communications with other data processing systems or devices, including resources of computer 300. In these examples, communications unit 310 includes one or more network interface cards. Communications unit 310 may provide communications through the use of either or both physical and wireless communications links. In various embodiments, primary OS 160 can be downloaded to persistent storage 308 through communications unit 310.

I/O interface(s) 312 allows for input and output of data with other devices that may be connected to computer 300. For example, I/O interface(s) 312 may provide a connection to external device(s) 316 such as a keyboard, a keypad, a touch screen, and/or some other suitable input device. External device(s) 316 can also include portable computer readable storage media such as, for example, thumb drives, portable optical or magnetic disks, and memory cards. Software and data used to practice embodiments of the present invention, (e.g., primary OS 160), can be stored on such portable computer readable storage media and can be loaded onto persistent storage 308 via I/O interface(s) 312. I/O interface(s) 312 also connect to a display 318.

Display 318 provides a mechanism to display data to a user and may be, for example, a computer monitor. Display 318 can also function as a touchscreen, such as a display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for core utilization, based on core clocks, the method comprising:
identifying, by one or more processors, a faulty clock, in a core of a plurality of cores in a multi-core computing system;
initiating, by one or more processors, a recovery procedure for the faulty clock in the core of the plurality of cores;
determining, by one or more processors, that the faulty clock, in the core of the plurality of cores, was not recovered; and
adjusting, by one or more processors, functionality of the core, of the plurality of cores, with the faulty clock.

2. The method of claim 1, wherein the step of identifying, by one or more processors, a faulty clock, in a core of a plurality of cores, in a multi-core computing system comprises:
determining that all clocks in the multi-core computing system are not synchronized; and
verifying that a system clock in the multi-core computing system is functioning correctly.

3. The method of claim 2, wherein the faulty clock, in the core of the plurality of cores, is not synchronized with the system clock.

4. The method of claim 2, wherein the step of verifying that the system clock in the multi-core computing system is functioning correctly comprises:
executing an internal check to verify integrity of a time of day value as seen by each core in the multi-core computing system.

5. The method of claim 1, wherein the recovery procedure includes one of the following: a redundant clock topology; a redundant oscillator; and a redundant master clock.

6. The method of claim 2, wherein the step of determining by one or more processors, that the faulty clock, in the core of the plurality of cores, was not recovered comprises:
checking whether the faulty clock is synchronized with the system clock.

7. The method of claim 1, wherein the step of adjusting, by one or more processors, the functionality of the core, of the plurality of cores, with the faulty clock comprises:
assigning to the core with the faulty clock, non-clock dependent operations.

8. The method of claim 7, wherein the non-clock dependent operations do not require an accurate clock reference to function properly and do not interact with other cores in the multi-processor computing system.

9-20. (canceled)
